(19) United States
(12) Patent Application Publication
(10) Pub. No.: US 2017/0301060 A1
(43) Pub. Date: Oct. 19, 2017

(54) IMAGE PROCESSING METHOD AND PORTABLE ELECTRONIC APPARATUS

(71) Applicant: AVISONIC TECHNOLOGY CORPORATION, HSINCHU (TW)

(72) Inventor: CHI-CHANG YU, KEELUNG CITY (TW)

(21) Appl. No.: 15/281,696

(22) Filed: Sep. 30, 2016

Related U.S. Application Data
(60) Provisional application No. 62/324,875, filed on Apr. 19, 2016.

(30) Foreign Application Priority Data
Jun. 27, 2016 (TW) 105120109

(51) Int. Cl. G06T 3/00; H04N 5/232

(52) U.S. Cl. CPC G06T 3/0093; H04N 5/23229

(57) ABSTRACT

An image processing method for a portable electronic apparatus having a processing unit is provided. The image processing method includes steps of acquiring an image, executing an optical center analysis procedure for the image by the processing unit to determine an optical center, and executing an image geometric correction procedure according to the optical center and visual angle information by the processing unit to generate a corrected image.

### CROSS-REFERENCE TO RELATED APPLICATIONS

This application claims the benefit of U.S. provisional application No. 62/324,875, filed on Apr. 19, 2016, the disclosure of which is incorporated herein in its entirety by reference.

This application claims the benefit of Taiwan patent application No. 105120109, filed on Jun. 27, 2016, the disclosure of which is incorporated herein in its entirety by reference.

### BACKGROUND

### 1. Technical Field

The present invention relates generally to an image processing method, and more particularly to an image processing method for a portable electronic apparatus.

### 2. Description of Related Art

At present, a portable electronic apparatus, such as a smart phone, a tablet computer, and so on, provides a lens for capturing images or videos. Further, an external lens, such as a fisheye lens, may be mounted on the lens to capture wide-angle images or videos. In general, the external lens is clipped on the portable electronic apparatus through a fixture or other manners. However, the quality of captured images or videos is significantly affected once the lens of the portable electronic apparatus is not aligned with the external lens.

### SUMMARY

An objective of the present invention is to provide an image processing method and a portable electronic apparatus so as to solve the above-mentioned problem.

The present invention provides an image processing method for a portable electronic apparatus having a processing unit. The image processing method includes steps of acquiring an image, executing an optical center analysis procedure for the image by the processing unit to determine an optical center, and executing an image geometric correction procedure according to the optical center and visual angle information by the processing unit to generate a corrected image.

The present invention further provides a non-transitory computer-readable recording medium storing a program for being executed on a processing unit to perform the above-mentioned steps.

The present invention further provides a portable electronic apparatus. The portable electronic apparatus includes an image-capturing unit and a processing unit. The image-capturing unit captures an image. The processing unit executes an optical center analysis procedure for the image to determine an optical center, and executes an image geometric correction procedure according to the optical center and visual angle information to generate a corrected image.

The present invention further provides an image processing method for a portable electronic apparatus having a processing unit. The image processing method includes steps of acquiring a first image and a second image, executing an optical center analysis procedure for the first image and the second image by the processing unit to determine a first optical center and a second optical center, analyzing the first image and the second image by the processing unit to acquire common feature information of a superimposed region of the first image and the second image, correcting the first image according to the first optical center and first visual angle information by the processing unit to generate a first corrected image, and correcting the second image according to the second optical center and second visual angle information by the processing unit to generate a second corrected image, and stitching the first corrected image and the second corrected image by the processing unit to generate a stitched image according to the common feature information of the superimposed region of the first image and the second image.

The present invention further provides a non-transitory computer-readable recording medium storing a program for being executed on a processing unit to perform the above-mentioned steps.

The present invention further provides a portable electronic apparatus. The portable electronic apparatus includes a first image-capturing, a second image-capturing unit, and a processing unit. The first image-capturing unit captures a first image. The second image-capturing unit captures a second image. The processing unit executes an optical center analysis procedure for the first image and the second image to determine a first optical center and a second optical center, analyzes the first image and the second image to acquire common feature information of a superimposed region of the first image and the second image, executes an image geometric correction procedure according to the first optical center and first visual angle information to generate a first corrected image, executes the image geometric correction procedure according to the second optical center and second visual angle information to generate a second corrected image, and stitches the first corrected image and the second corrected image to generate a stitched image according to the common feature information of the superimposed region of the first image and the second image.

It is to be understood that both the foregoing general description and the following detailed description are exemplary, and are intended to provide further explanation of the present invention as claimed. Other advantages and features of the present invention will be apparent from the following description, drawings and claims.

### BRIEF DESCRIPTION OF DRAWINGS

FIG. 1 is a schematic block view of a portable electronic apparatus according to one embodiment of the present invention;

FIG. 2 is a flowchart of an image processing method according to the present invention;

FIG. 3 is a schematic view of executing an optical center analysis procedure according to the present invention;

FIG. 4 is a schematic block view of the portable electronic apparatus according to another embodiment of the present invention;

FIG. 5 is another flowchart of the image processing method according to the present invention;

FIG. 6A is a schematic view of feature information of a first image according to the present invention; and

FIG. 6B is a schematic view of feature information of a second image according to the present invention.

### DETAILED DESCRIPTION

Reference will now be made to the drawing figures to describe the present invention in detail.

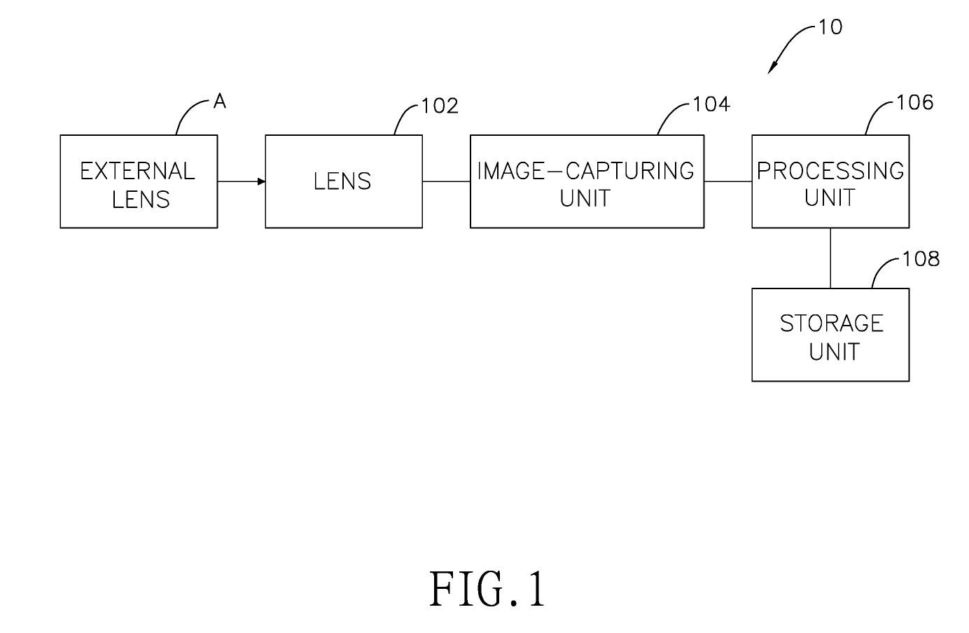

FIG. 1 is a schematic block view of a portable electronic apparatus 10 according to one embodiment of the present invention. The portable electronic apparatus 10 includes a lens 102, an image-capturing unit 104, a processing unit 106, and a storage unit 108. The image-capturing unit 104 includes image sensors, such as complementary metal-oxide semiconductor (CMOS) or charge-coupled device (CCD) for capturing images via the lens 102. The processing unit 106 is used to process the images captured by the image-capturing unit 104. The portable electronic apparatus 10 may be a smart phone, a tablet computer, or other portable electronic apparatus. Further, an external lens A is provided in the present invention, and the external lens A may be a fisheye lens. The external lens A can be mounted on the portable electronic apparatus 10 via a connecting fixture or other manners so that the external lens A is superimposed on the lens 102. In general, a deviation between an optical center of the external lens A and an optical center of the lens 102 occurs since the external lens A is manually mounted on the lens 102 by a user. The deviation affects the images captured by the image-capturing unit 104.

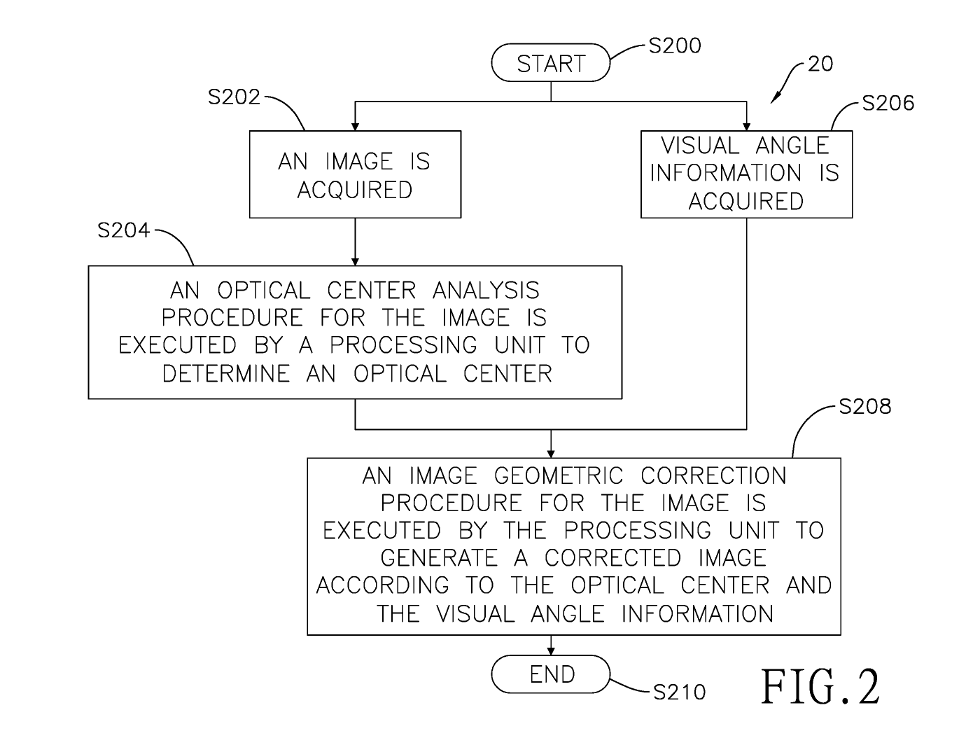

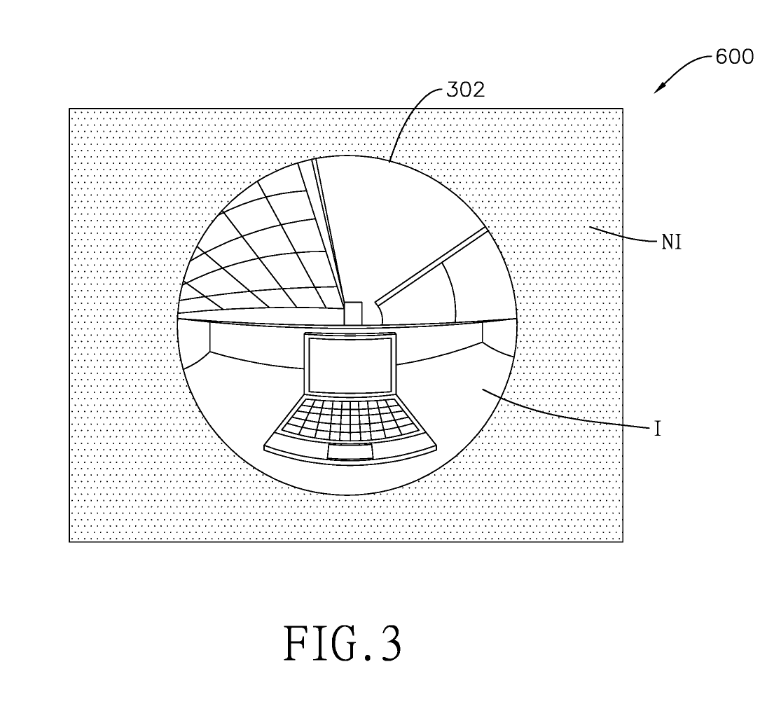

In the following disclosure, a fisheye lens is exemplified as the external lens A for further demonstration of operations of the processing unit 106. FIG. 2 is a flowchart of an image processing method according to the present invention. After the external lens A is installed on the portable electronic apparatus 10, the image-capturing unit 104 captures an image through the external lens A and the lens 102 and produces an image 600. In step S202, the processing unit 106 receives the image 600. In step S204, the processing unit 106 executes an optical center analysis procedure for the image 600 to determine an optical center OC. For example, the optical center OC is determined by the processing unit 106 according to edge pixel information of the image 600. The edge pixel information is related to a junction formed between an imaging region I and a non-imaging region NI of the image 600. As shown in FIG. 3, a circular junction is formed between a non-imaging region NI, i.e., a black dotted region and an imaging region I of the image 600 when the fisheye lens is exemplified as the external lens A. In this condition, a circle 302 is found by using an edge detection algorithm and a center of the circle 302 is calculated. The center is as the optical center OC of the image 600.

In other embodiments, some factors such as the deviation between the external lens A and the lens 102 or an insufficient imaging scope of the image-capturing unit 104 may affect the image 600. For example, a junction formed between the non-imaging region NI and the imaging region I is not a full circle as circle 302. A geometric center, which is as the optical center OC of the image 600, could be calculated according to the non-circular junction, such as curved junction between the non-imaging region NI and the imaging region I. In addition, other algorithms used to calculate the optical center OC of the fisheye image could be applied to the present invention.

In step S206, the processing unit 106 acquires visual angle information. The visual angle information may be a focal length of the external lens A or a default value. Also, the visual angle information may be a visual angle value provided by the user. For example, the user may input the visual angle value to the processing unit 106 by an application program executed on the portable electronic apparatus 10.

In step S208, an image geometric correction procedure is executed for the image 600 by the processing unit 106 to generate a corrected image 600′ according to the optical center OC acquired in step S204 and the visual angle information acquired in step S206. The image geometric correction procedure provides an image distortion correction for the image 600. In one embodiment, the imaging region I within the circle 302 shown in FIG. 3 is corrected through the image geometric correction procedure to generate the corrected image 600′. Since the correction technology of processing the fisheye images is an existing technology, the detail description is omitted here for conciseness.

The deviation between the external lens A and the lens 102 may result in that the imaging region I is not at the center of the image 600. The processing unit 106 determines the optical center OC according to the images captured by the image-capturing unit 104, and executes image geometric correction for the captured images. The correction including improving the distortion of the fisheye image and converting the improved fisheye image into a corrected image increases the quality of the captured images.

In other embodiments, information of the optical center OC acquired in step S204 and the visual angle information acquired in step S206 may be stored in the storage unit 108 for executing the image geometric correction procedure to subsequent images, thus improving efficiency of the image geometric correction procedure without always executing the optical center analysis procedure for each of subsequent images.

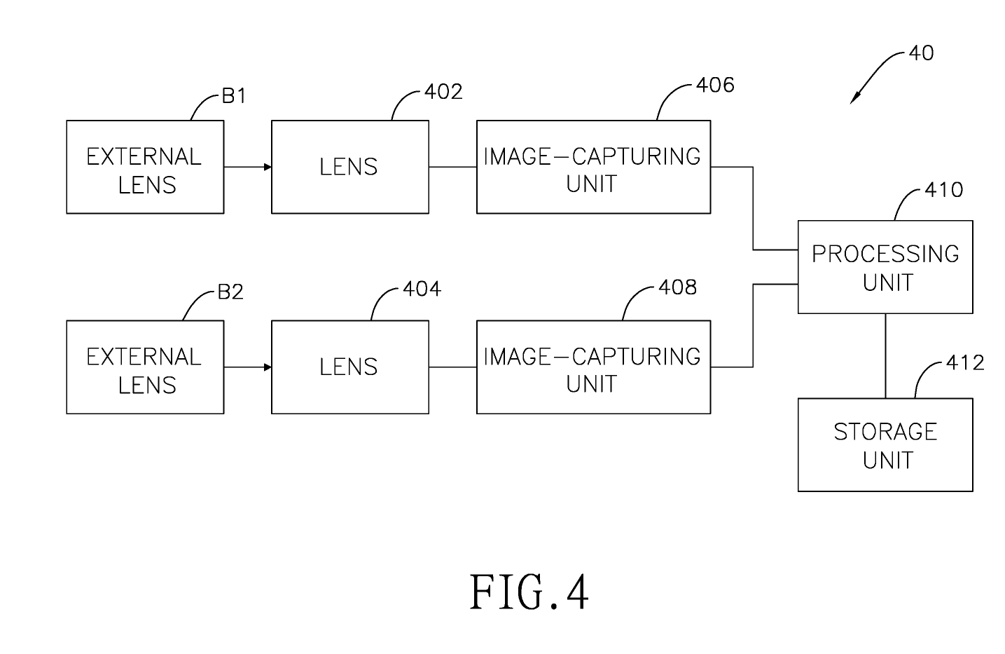

FIG. 4 is a schematic block view of a portable electronic apparatus 40 according to another embodiment of the present invention. The portable electronic apparatus 40 includes lenses 402,404, image-capturing units 406,408, a processing unit 410, and a storage unit 412. In one embodiment, the lens 402 is installed on a front side of the portable electronic apparatus 40 and the lens 404 is installed on a rear side of the portable electronic apparatus 40. The image-capturing unit 406 is used to capture images in front of the portable electronic apparatus 40 and the image-capturing unit 408 is used to capture images behind the portable electronic apparatus 40. Both the image-capturing unit 406 and the image-capturing unit 408 have image sensors, such as CMOS or CCD. The processing unit 410 processes the images captured by the image-capturing unit 406 and the image-capturing unit 408. The portable electronic apparatus 40 may be a smart phone, a tablet computer, or other portable electronic apparatus.

Further, external lenses B1,B2 are provided, and both the external lenses B1,B2 may be fisheye lenses. The external lenses B1,B2 can be mounted on the portable electronic apparatus 40 via a connecting fixture or other manners so that the external lens B1 and the external lens B2 are superimposed on the lens 402 and the lens 404, respectively. In general, a deviation between an optical center of the external lens B1 and an optical center of the lens 402 occurs since the external lens B1 is manually mounted on the lens 402 by the user. The deviation affects the images captured by the image-capturing unit 406. Also, a deviation between an optical center of the external lens B2 and an optical center of the lens 404 occurs since the external lens B2 is manually mounted on the lens 404 by the user. The deviation affects the images captured by the image-capturing unit 408.

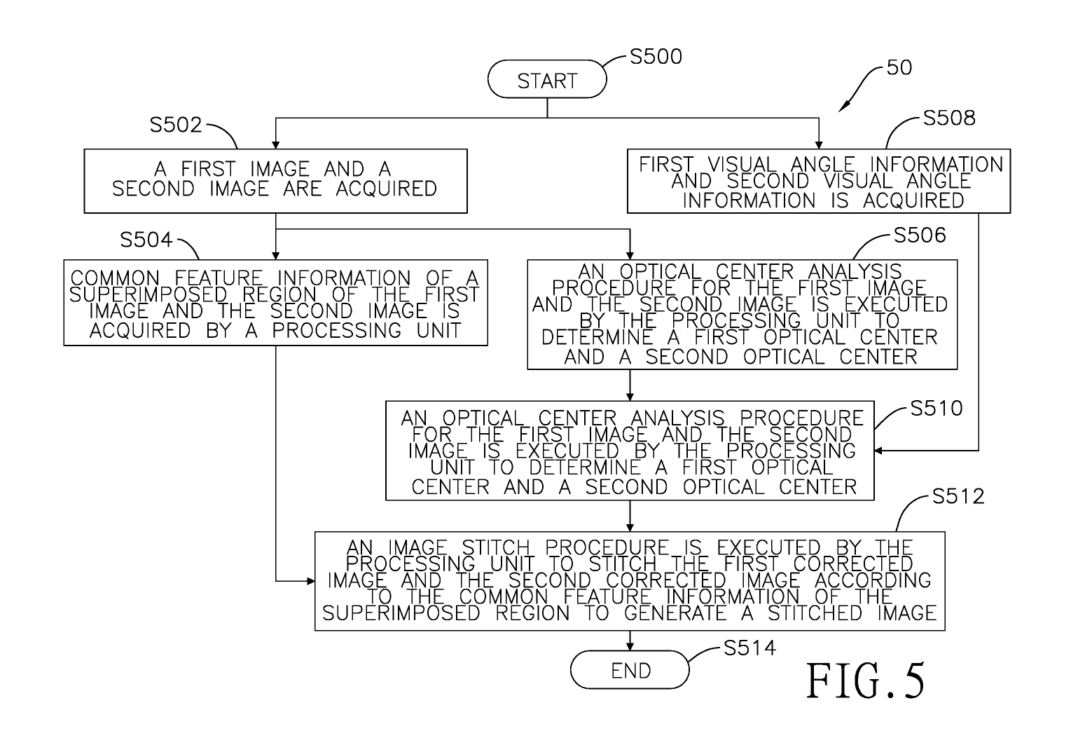

In the following disclosure, fisheye lenses are exemplified as the external lenses B1,B2 for further demonstration of operations of the processing unit 410. FIG. 5 is another flowchart of the image processing method according to the present invention. After both the external lens B1 and the external lens B2 are installed on the portable electronic apparatus 10, the image-capturing unit 406 captures an image through the external lens B1 and the lens 402 and produces a first image 601. Similarly, the image-capturing unit 408 captures an image through the external lens B2 and the lens 404 and produces a second image 602. In step S502, the processing unit 410 receives the first image 601 from the image-capturing unit 406 and the second image 602 from the image-capturing unit 408.

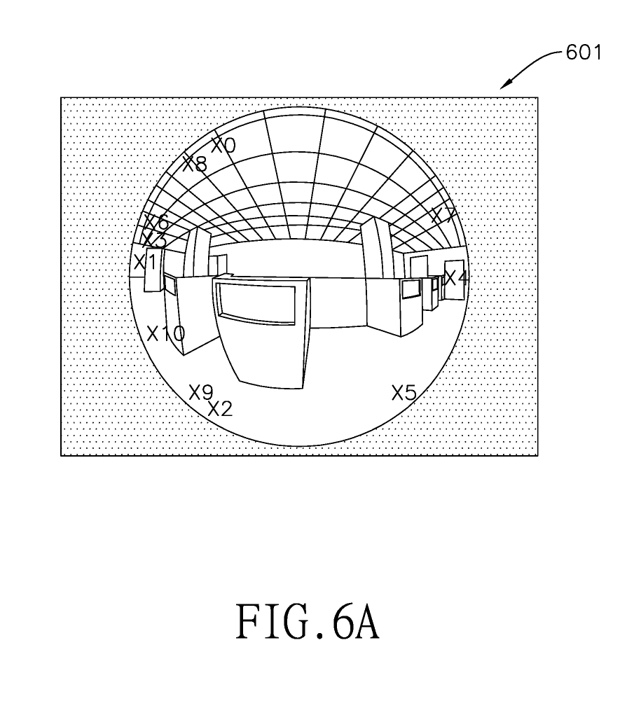

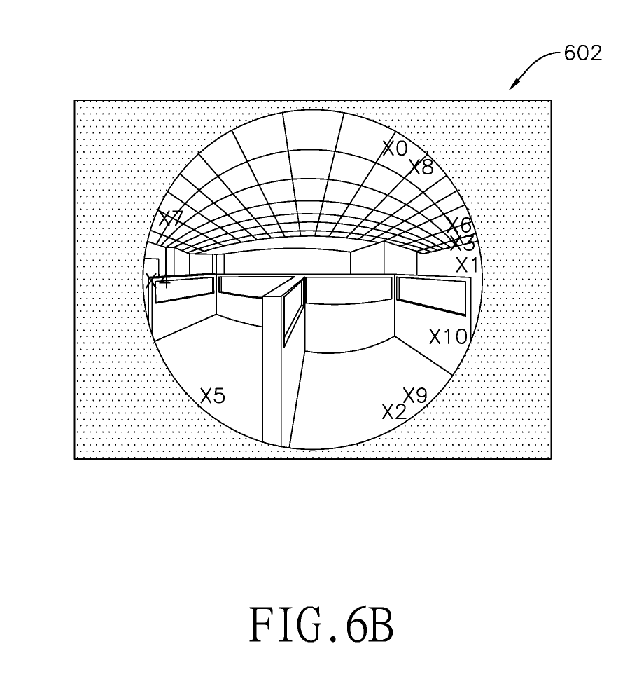

In step S504, the processing unit 410 analyzes the first image 601 and the second image 602 to acquire common feature information of a superimposed region of the first image 601 and the second image 602. Also, correction parameters are further acquired according to the common feature information of the superimposed region of the first image 601 and the second image 602. For example, a scale-invariant feature transform (SIFT) algorithm is used to acquire the common feature information, such as positions of common feature points of the superimposed region of the first image 601 and the second image 602. FIG. 6A and FIG. 6B show an example of common feature point. The first image 601 and the second image 602 shown in FIG. 6A and FIG. 6B are respectively acquired by the external lens B1 and the external lens B2. By using the SIFT algorithm, a plurality of common feature points X0-X9 of the superimposed region of the first image 601 and the second image 602 are identified.

In step S506, the processing unit 410 executes the optical center analysis procedure to determine a first optical center OC_1. The processing unit 410 executes the optical center analysis procedure to determine a second optical center OC_2. Since the optical center analysis procedure has been disclosed in foregoing step S204 and FIG. 3, the detail description is omitted here for conciseness.

In step S508, the processing unit 410 acquires first visual angle information of the first image 601 and second visual angle information of the second image 602. The first visual angle information may be a focal length of the external lens B1 or a default value. Similarly, the second visual angle information may be a focal length of the external lens B2 or a default value. Also, the first visual angle information and the second visual angle information may be visual angle values provided by the user. For example, the user may input the visual angle values to the processing unit 106 by an application program executed on the portable electronic apparatus 40.

In step S510, an image geometric correction procedure is executed for the first image 601 by the processing unit 410 to generate a first corrected image 601′ according to the first optical center OC_1 acquired in step S506 and the first visual angle information acquired in step S508. Also, the image geometric correction procedure is executed for the second image 602 by the processing unit 410 to generate a second corrected image 602′ according to the second optical center OC_2 acquired in step S506 and the second visual angle information acquired in step S508.

In step S512, the processing unit 410 executes an image stitch procedure to stitch the first corrected image 601′ and the second corrected image 602′ according to the common feature information of the superimposed region of the first image 601 and the second image 602 and the correction parameters acquired in foregoing step S504 to generate a stitched image 603.

In other embodiments, the correction parameters acquired in step S504, information of the first optical center OC_1 and information of the second optical center OC_2 acquired in step S506, and the first visual angle information and the second visual angle information acquired in step S508 may be stored in the storage unit 412 for executing the image geometric correction procedure and the image stitch procedure to subsequent images.

As shown in FIG. 5, the image captured in front of the portable electronic apparatus 40 and the image captured behind the portable electronic apparatus 40 are stitched to create a spherical-typed (360-degree) panoramic image. Also, a video recorded in front of the portable electronic apparatus 40 and a video recorded behind the portable electronic apparatus 40 are stitched to create a spherical-typed (360-degree) panoramic video.

Although the present invention has been described with reference to the preferred embodiment thereof, it will be understood that the present invention is not limited to the details thereof. Various substitutions and modifications have been suggested in the foregoing description, and others will occur to those of ordinary skill in the art. For example, any one of the external lenses A,B1,B2 may be a wide-angle lens or other type of external lens. In addition, any one of the portable electronic apparatuses 10,40 may be a smart phone, a tablet computer, a wearable device, a notebook computer, a camera, a portable multimedia player, or an electronic apparatus with a camera function. In addition, any one of the processing units 106,410 may have one or more than one processor for performing the steps shown in FIG. 2 and FIG. 5. For example, the processing unit 106 (or the processing unit 410) has a processor to execute the optical center analysis procedure and the image geometric correction procedure, or the processing unit 106 (or the processing unit 410) has two processors to execute the optical center analysis procedure and the image geometric correction procedure, respectively.

In addition, the present invention further provides a computer-readable recording medium having a stored program. The stored program is loaded into a processing unit and executed by the processing unit to complete the above-mentioned steps shown in FIG. 2 and FIG. 5.

Although the present invention has been described with reference to the preferred embodiment thereof, all such substitutions and modifications are intended to be embraced within the scope of the present invention as defined in the appended claims.

What is claimed is:

1. An image processing method for a portable electronic apparatus having a processing unit, the image processing method comprising steps of:
acquiring an image;
executing an optical center analysis procedure for the image by the processing unit to determine an optical center; and
executing an image geometric correction procedure according to the optical center and visual angle information by the processing unit to generate a corrected image.

2. The image processing method as claimed in claim 1, wherein the step of executing the optical center analysis procedure for the image by the processing unit to determine the optical center comprises:
determining the optical center by the processing unit according to edge pixel information of the image.

3. The image processing method as claimed in claim 1, wherein the visual angle information is a focal length of an external lens configured to capture the image, a visual angle value provided by a user, or a default value.

4. The image processing method as claimed in claim 1, further comprising:
storing information of the optical center and the visual angle information for correcting subsequent images.

5. The image processing method as claimed in claim 1, wherein the image is a fisheye image.

6. A non-transitory computer-readable recording medium storing a program for being executed on a processing unit to perform steps of:
acquiring an image;
executing an optical center analysis procedure for the image by the processing unit to determine an optical center; and
executing an image geometric correction procedure according to the optical center and visual angle information by the processing unit to generate a corrected image.

7. The non-transitory computer-readable recording medium as claimed in claim 6, wherein the step of executing the optical center analysis procedure for the image by the processing unit to determine the optical center comprises:
determining the optical center by the processing unit according to edge pixel information of the image.

8. The non-transitory computer-readable recording medium as claimed in claim 6, wherein the visual angle information is a focal length of an external lens configured to capture the image, a visual angle value provided by a user, or a default value.

9. The non-transitory computer-readable recording medium as claimed in claim 6, further comprising:
storing information of the optical center and the visual angle information for correcting subsequent images.

10. The non-transitory computer-readable recording medium as claimed in claim 6, wherein the image is a fisheye image.

11. A portable electronic apparatus, comprising:
an image-capturing unit configured to capture an image; and
a processing unit configured to execute an optical center analysis procedure for the image to determine an optical center, and executing an image geometric correction procedure according to the optical center and visual angle information to generate a corrected image.

12. The portable electronic apparatus as claimed in claim 11, wherein the processing unit is configured to determine the optical center according to edge pixel information of the image.

13. The portable electronic apparatus as claimed in claim 11, wherein the visual angle information is a focal length of an external lens configured to capture the image, a visual angle value provided by a user, or a default value.

14. The portable electronic apparatus as claimed in claim 11, further comprising:
a storage unit configured to store information of the optical center and the visual angle information for correcting subsequent images.

15. The portable electronic apparatus as claimed in claim 11, wherein the image is a fisheye image.

16. An image processing method for a portable electronic apparatus having a processing unit, the image processing method comprising steps of:
acquiring a first image and a second image;
executing an optical center analysis procedure for the first image and the second image by the processing unit to determine a first optical center and a second optical center;
analyzing the first image and the second image by the processing unit to acquire common feature information of a superimposed region of the first image and the second image;
correcting the first image according to the first optical center and first visual angle information by the processing unit to generate a first corrected image, and correcting the second image according to the second optical center and second visual angle information by the processing unit to generate a second corrected image; and
stitching the first corrected image and the second corrected image by the processing unit to generate a stitched image according to the common feature information of the superimposed region of the first image and the second image.

17. The image processing method as claimed in claim 16, wherein the step of executing the optical center analysis procedure for the first image and the second image by the processing unit to determine the first optical center and the second optical center comprises:
determining the first optical center by the processing unit according to edge pixel information of the first image; and
determining the second optical center by the processing unit according to edge pixel information of the second image.

18. The image processing method as claimed in claim 16, wherein the first visual angle information is a focal length of a first external lens configured to capture the first image, a first visual angle value provided by a user, or a first default value; wherein the second visual angle information is a focal length of a second external lens configured to capture the second image, a second visual angle value provided by the user, or a second default value.

19. The image processing method as claimed in claim 16, further comprising:
storing information of the first optical center, information of the second optical center, the first visual angle information, and the second visual angle information for correcting subsequent images; and
storing correction parameters acquired according to the common feature information of the superimposed region of the first image and the second image for stitching subsequent images.

20. The image processing method as claimed in claim 16, wherein the first image and the second image are fisheye images.

21. A non-transitory computer-readable recording medium storing a program for being executed on a processing unit to perform steps of:
acquiring a first image and a second image;
executing an optical center analysis procedure for the first image and the second image by the processing unit to determine a first optical center and a second optical center;
analyzing the first image and the second image by the processing unit to acquire common feature information of a superimposed region of the first image and the second image;
correcting the first image according to the first optical center and first visual angle information by the processing unit to generate a first corrected image, and correcting the second image according to the second optical center and second visual angle information by the processing unit to generate a second corrected image; and
stitching the first corrected image and the second corrected image by the processing unit to generate a stitched image according to the common feature information of the superimposed region of the first image and the second image.

22. The non-transitory computer-readable recording medium as claimed in claim 21, wherein the step of executing the optical center analysis procedure for the first image and the second image by the processing unit to determine the first optical center and the second optical center comprises:
determining the first optical center by the processing unit according to edge pixel information of the first image; and
determining the second optical center by the processing unit according to edge pixel information of the second image.

23. The non-transitory computer-readable recording medium as claimed in claim 21, wherein the first visual angle information is a focal length of a first external lens configured to capture the first image, a first visual angle value provided by a user, or a first default value; wherein the second visual angle information is a focal length of a second external lens configured to capture the second image, a second visual angle value provided by the user, or a second default value.

24. The non-transitory computer-readable recording medium as claimed in claim 21, further comprising:
storing information of the first optical center, information of the second optical center, the first visual angle information, and the second visual angle information for correcting subsequent images; and
storing correction parameters acquired according to the common feature information of the superimposed region of the first image and the second image for stitching subsequent images.

25. The non-transitory computer-readable recording medium as claimed in claim 21, wherein the first image and the second image are fisheye images.

26. A portable electronic apparatus, comprising:
a first image-capturing unit configured to capture a first image;
a second image-capturing unit configured to capture a second image; and
a processing unit configured to execute an optical center analysis procedure for the first image and the second image to determine a first optical center and a second optical center, analyze the first image and the second image to acquire common feature information of a superimposed region of the first image and the second image, execute an image geometric correction procedure according to the first optical center and first visual angle information to generate a first corrected image, execute the image geometric correction procedure according to the second optical center and second visual angle information to generate a second corrected image, and stitch the first corrected image and the second corrected image to generate a stitched image according to the common feature information of the superimposed region of the first image and the second image.

27. The portable electronic apparatus as claimed in claim 26, wherein the processing unit is configured to determine the first optical center according to edge pixel information of the first image, and the processing unit is configured to determine the second optical center according to edge pixel information of the second image.

28. The portable electronic apparatus as claimed in claim 26, wherein the first visual angle information is a focal length of a first external lens configured to capture the first image, a first visual angle value provided by a user, or a first default value; wherein the second visual angle information is a focal length of a second external lens configured to capture the second image, a second visual angle value provided by the user, or a second default value.

29. The portable electronic apparatus as claimed in claim 26, further comprising:
a storage unit configured to store information of the first optical center, information of the second optical center, the first visual angle information, and the second visual angle information for correcting subsequent images, and store correction parameters acquired according to the common feature information of the superimposed region of the first image and the second image for stitching subsequent images.

30. The portable electronic apparatus as claimed in claim 26, wherein the first image and the second image are fisheye images.
